(19) United States
(12) Patent Application Publication
(10) Pub. No.: US 2019/0020548 A1
(43) Pub. Date: Jan. 17, 2019

(54) METHOD AND APPARATUS FOR SETTING LOCATION INFORMATION

(71) Applicant: INSPUR ELECTRONIC INFORMATION INDUSTRY CO., LTD, Jinan, Shandong (CN)

(72) Inventor: Xiao SU, Jinan, Shandong (CN)

(73) Assignee: INSPUR ELECTRONIC INFORMATION INDUSTRY CO., LTD, Jinan, Shandong (CN)

(21) Appl. No.: 15/745,118

(22) PCT Filed: Dec. 13, 2016
(86) PCT No.: PCT/CN2016/109576

§ 371 Date: Jan. 15, 2018

(30) Foreign Application Priority Data
Aug. 30, 2016 (CN) 201610754261.1

(51) Int. Cl. H04L 12/24; H04L 12/26

(52) U.S. Cl. CPC H04L 41/12; H04L 43/065; H04L 41/0806

(57) ABSTRACT

A method and an apparatus for setting location information are provided. The method includes: determining a first location of a target node mid-plane to which a target node server is connected in a rack; determining a second location of the target node server in the target node mid-plane; determining actual location information of the target node server based on the first location and the second location corresponding to the target node server; acquiring current location information of the target node server; and judging whether the current location information of the target node server is identical to the actual location information, and setting location information of the target node server to be the actual location information in a case of a negative result. The efficiency of setting the location information can be improved with the method and the apparatus for setting location information.

### FIELD

The disclosure relates to the technical field of servers, and particularly to a method and an apparatus for setting location information.

### BACKGROUND

With the rapid development of Internet technologies, an increasing number of servers are used for processing data. Servers are generally arranged in racks in a server room. The number of racks increases with the number of servers. Hence, the location information of node servers in the racks needs to be set in order to manage the node servers in the racks more conveniently.

In the conventional technology, in the rack server system, maintenance personnel generally set the location information of the node servers in the racks by manually operating a FRU (Field Replace Unit) modification tool.

As can be seen from the above description, in the conventional technology, the location information of the node server in the rack is generally set by manually operating the FRU modification tool, which is inefficient.

### SUMMARY

A method and an apparatus for setting location information are provided according to the present disclosure, with which the efficiency of setting location information can be improved.

In one aspect, a method for setting location information is provided according to an embodiment of the present disclosure, which includes:

determining a first location of a target node mid-plane to which a target node server is connected in a rack;

determining a second location of the target node server in the target node mid-plane;

determining actual location information of the target node server based on the first location and the second location corresponding to the target node server;

acquiring current location information of the target node server; and

judging whether the current location information of the target node server is identical to the actual location information of the target node server, and setting location information of the target node server to be the actual location information in a case where the current location information of the target node server is not identical to the actual location information of the target node server.

Further, the determining the actual location information of the target node server based on the first location and the second location corresponding to the target node server may include:

determining a node location number of the target node server in the rack based on the first location and the second location;

determining rack location information of the rack; and

generating the actual location information based on the rack location information and the node location number.

Further, the acquiring the current location information of the target node server may include:

acquiring the current location information from a field “BMC (baseboard management controller) FRU chassis extra” of the target node server.

Further, the setting the location information of the target node server to be the actual location information may include:

controlling a BMC corresponding to the target node server to set content of the field “BMC FRU chassis extra” of the target node server to be the actual location information.

Further, the determining the rack location information of the rack may include:

using content of a field “RMC FRU chassis extra” of a RMC (rack management controller) of the rack as the rack location information.

In another aspect, an apparatus for setting location information is provided according to an embodiment of the present disclosure, which includes:

a first determination unit configured to determine a first location of a target node mid-plane to which a target node server is connected in a rack;

a second determination unit configured to determine a second location of the target node server in the target node mid-plane;

a third determination unit configured to determine actual location information of the target node server based on the first location and the second location corresponding to the target node server;

an acquisition unit configured to acquire current location information of the target node server; and

a judgment unit configured to judge whether the current location information of the target node server is identical to the actual location information of the target node server, and set location information of the target node server to be the actual location information in a case where the current location information of the target node server is not identical to the actual location information of the target node server.

Further, the third determination unit may be configured to determine a node location number of the target node server in the rack based on the first location and the second location;

determine rack location information of the rack; and generate the actual location information based on the rack location information and the node location number.

Further, the acquisition unit may be configured to acquire the current location information from a field “BMC FRU chassis extra” of the target node server.

Further, the judgment unit may be configured to control a BMC corresponding to the target node server to set content of the field “BMC FRU chassis extra” of the target node server to be the actual location information when setting the location information of the target node server to be the actual location information.

Further, the third determination unit may be configured to use content of a field “RMC FRU chassis extra” of a RMC of the rack as the rack location information when determining the rack location information of the rack.

In the embodiments of the present disclosure, the actual location information of the target node server is determined based on the first location of the target node mid-plane to which the target node server is connected in the rack and the second location of the target node server in the target node mid-plane. The actual location of the target node server can be automatically determined with the method without manual searching. In a case of determining that the current location information of the target node server is different from the actual location information of the target node server, the location information of the target node server is automatically set to be the actual location information without manual setting, which improves the efficiency of setting the location information.

### BRIEF DESCRIPTION OF THE DRAWINGS

The drawings to be used in the description of the embodiments of the present disclosure or the conventional technology will be described briefly as follows, so that the technical solutions according to the embodiments of the present disclosure or according to the conventional technology will become clearer. It is apparent that the drawings in the following description only illustrate some embodiments of the present disclosure. For those skilled in the art, other drawings may be obtained according to these drawings without any creative work.

FIG. 1 is a flow chart of a method for setting location information according to an embodiment of the present disclosure;

FIG. 2 is a flow chart of a method for setting location information according to another embodiment of the present disclosure;

FIG. 3 is a schematic diagram of an apparatus for setting location information according to an embodiment of the present disclosure; and

FIG. 4 is a schematic diagram of an apparatus for setting location information according to another embodiment of the present disclosure.

### DETAILED DESCRIPTION OF THE EMBODIMENTS

In order that the objectives, technical solutions and advantages of the present disclosure can be clearer, the technical solution according to the embodiments of the present disclosure will be described clearly and completely as follows in conjunction with the drawings. It is apparent that the described embodiments are only a few rather than all of the embodiments according to the present disclosure. Any other embodiments obtained by those skilled in the art based on the embodiments in the present disclosure without any creative work fall in the scope of the present disclosure.

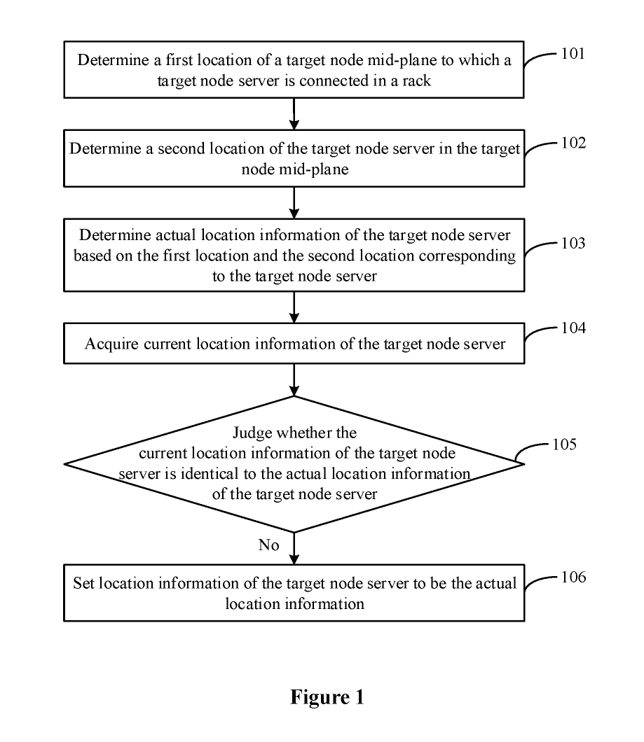

As shown in FIG. 1, a method for setting location information is provided according to an embodiment of the present disclosure. The method may include the following steps 101-106.

In step 101, a first location of a target node mid-plane to which a target node server is connected in a rack is determined.

In step 102, a second location of the target node server in the target node mid-plane is determined.

In step 103, actual location information of the target node server is determined based on the first location and the second location corresponding to the target node server.

In step 104, current location information of the target node server is acquired.

In step 105, it is judged whether the current location information of the target node server is identical to the actual location information of the target node server. Step 106 is executed in a case where the current location information of the target node server is not identical to the actual location information of the target node server.

In step 106, location information of the target node server is set to be the actual location information.

In the embodiment of the present disclosure, the actual location information of the target node server is determined based on the first location of the target node mid-plane to which the target node server is connected in the rack and the second location of the target node server in the target node mid-plane. The actual location of the target node server can be automatically determined with the method without manual searching. In a case of determining that the current location information of the target node server is different from the actual location information of the target node server, the location information of the target node server is automatically set to be the actual location information without manual setting, which improves the efficiency of setting the location information.

In an embodiment of the present disclosure, the step 103 includes:

determining a node location number of the target node server in the rack based on the first location and the second location;

determining rack location information of the rack; and

generating the actual location information based on the rack location information and the node location number.

Generally, the node server on each layer of the rack is connected to the node mid-plane via an I2C bus, and the node mid-plane on each layer of the rack is connected to a RMC of the rack via an I2C bus. Generally, one node mid-plane is provided on each layer, and each node mid-plane may be connected to multiple node servers, such as 4 node servers or 8 node servers.

In the embodiment of the present disclosure, the actual location information includes the location of the rack and the location of the target node server in the rack, and the location of the target node server in the rack may be determined based on the first location and the second location. The actual location information may be represented in the following format: the rack location information-the node location number. Fox example, the location of the rack is the third rack in the second column in the server room 101, and the rack location information may be jifang101 di2lie di3ge. Of course, the location of the rack may include information of country, province, city and building where the rack is located, such as building A in zhongguancun, Beijing, China. The first location of the target node mid-plane in the rack is: the first target node mid-plane on the second layer of the rack. The second location of the target node server in the target node mid-plane is the third target node server. The node location number of the target node server may be 020103, where 02 indicates that the target node mid-plane is on the second layer of the rack, 01 indicates that the target node mid-plane is the first target node mid-plane on a layer of the rack, and 03 indicates that the target node server is the third target node server in the target node mid-plane. The actual location information may be represented by jifang101 di2lie di3ge-020103. Of course, the rack location information and the node location number may be represented in other manners. For example, the rack location information is represented by a capital letter and a number, and the node location number is represented by a sequence number. For example, there are 9 node servers in the rack, and the node location number is represented by 1 to 9. Specifically, the node location number is set for the node server in an order from the bottom layer to the top layer of the rack and from left to right in a same layer.

In an embodiment of the present disclosure, the determining the rack location information of the rack includes:

using content of a field “RMC FRU chassis extra” of the a RMC of the rack as the rack location information.

The rack location information is typically stored in the field “RMC FRU chassis extra” of the RMC. In this embodiment, the rack location information may be determined by acquiring the content of the field “RMC FRU chassis extra” of the RMC.

Further, in an embodiment of the present disclosure, the determining the rack location information of the rack may be implemented in the following manner.

In a case where more than half of the node servers in the rack have the same first rack location information of the current location information, the first rack location information is used as the rack location information of the rack.

This implementation may be applied to the case of a replaced RMC. Due to the possibility that the rack location information in the currently replaced RMC is inaccurate, accurate rack location information may be determined with this implementation. Furthermore, in a case where the current rack location information in the RMC of the rack is different from the first rack location information, the rack location information in the RMC of the rack is set to be the first rack location information. Automatic update of the rack location information in the RMC may be achieved by stetting the rack location information in the RMC in this manner.

In an embodiment of the present disclosure, the step 104 includes:

acquiring the current location information from a field “BMC FRU chassis extra” of the target node server.

The target node server is generally stored in the field “BMC FRU chassis extra” of a corresponding BMC. In this embodiment, the current location information of the target node server may be acquired from the field “BMC FRU chassis extra” of the target node server. In this case, the current location information may be inaccurate and may be a default setting in the target node server, which does not indicate the actual location of the target node server. For example, the target node server is a node server in a new rack, a new node server provided in the rack, or a new node server for replacing a previous node server.

In an embodiment of the present disclosure, the setting the location information of the target node server to be the actual location information in the step 106 includes:

controlling a BMC corresponding to the target node server to set content of the field “BMC FRU chassis extra” of the target node server to be the actual location information.

Specifically, a setting command may be sent to the BMC corresponding to the target node server, where the setting command includes the actual location information. The BMC sets the content of the field “BMC FRU chassis extra” of the target node server to be the actual location information according to the setting command. Specifically, the setting command is sent to the BMC by the RMC via the target node mid-plane. Taking the above described actual location information as an example, the actual location information is: jifang101 di2lie di3ge-020103, and the content of the field “BMC FRU chassis extra” of the target node server is set to jifang101 di2lie di3ge-020103.

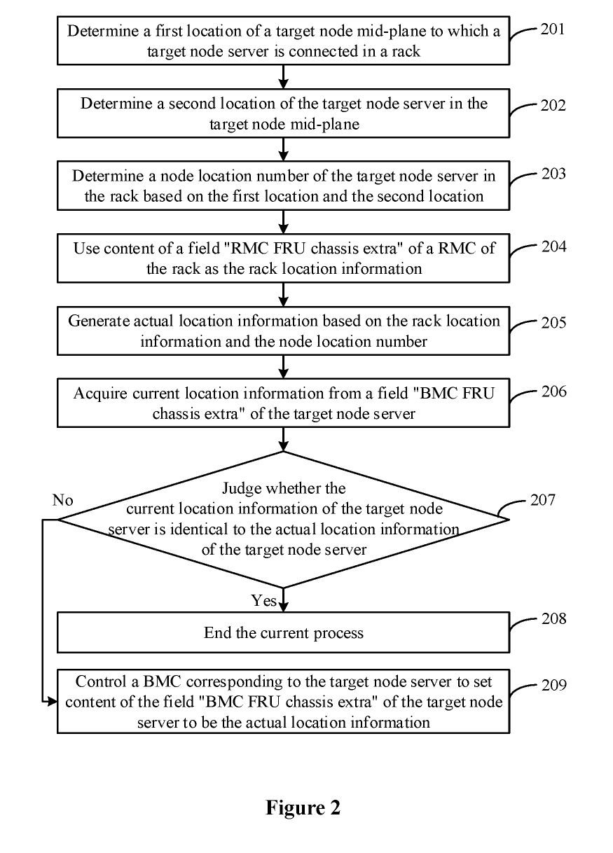

As shown in FIG. 2, a method for setting location information is provided according to an embodiment of the present disclosure. In this embodiment, the method may include the following steps 201 to 209.

In step 201, a first location of a target node mid-plane to which a target node server is connected in the rack is determined.

Specifically, a correspondence between the location of the node mid-plane in the rack and an identification of the node mid-plane may be preset, an identification of the target node to which the target node server is connected is determined, and the first location is determined based on the identification of the target node and the correspondence. As an example, the location of the node mid-plane in the rack may be represented by a layer number of the layer on which the node mid-plane is located in the rack. For example, if the node mid-plane A is on the second layer of the rack, in the correspondence, the identification of the node mid-plane A corresponds to the second layer. If the node mid-plane A is the target node, the first location is the second layer of the rack.

Moreover, the location of the node mid-plane may be determined based on the location of a GPIO (General Purpose Input Output) on the rack to which the node mid-plane is connected.

In step 202, a second location of the target node server in the target node mid-plane is determined.

Specifically, an interface connected to the target node server on the target node mid-plane is determined, and an identification of the interface is used as the second location. For example, the target node server is connected to an interface A on the target node mid-plane, where the identification of the interface A is 01. Therefore, the second location is the location of the interface of which the identification is 01 on the target node mid-plane. If the interface of which the identification is 01 is found, the target node server is found.

Step 203: a node location number of the target node server in the rack is determined based on the first location and the second location.

Taking the above described target node server as an example, if the first location is the second layer of the rack, and the second location is the location of the interface on the target node mid-plane of which the identification is 01, the node location number may be determined to be 0201, where 02 indicates that the node mid-plane is located on the second layer of the rack, and 01 indicates the location of the interface on the target node mid-plane of which the identification is 01, i.e., the location of the interface connected to the target node server. Moreover, in a case of determining that the target node server is the first node server on the second layer of the rack based on the first location and the second location, and there are 4 node servers on the first layer, the node location number of the target node server in the rack may be determined to be 05 according to the order in which the node servers is arranged in the rack, where 05 indicates that the target node server is the fifth node server in the rack. The node location number may be set in an order from the top layer to the bottom layer of the rack and from left to right in a same layer. The first layer is the top layer, and the target node server is the left-most node server on the second layer. Thus, the node location number of the target node server in the rack is 05.

In step 204, content of a field “RMC FRU chassis extra” of a RMC of the rack is used as the rack location information.

The rack location information is determined in this manner. Of course, the rack location information may be determined in other manners. For example, a correspondence between the rack location information and an identification of the rack is established in advance, the identification of the rack where the target node server is located is determined, and the rack location information of the rack is determined based on the identification and the correspondence.

In step 205, actual location information is generated based on the rack location information and the node location number.

For example, in a case where the rack location information corresponding to the target node server is jifang101 di2lie di3ge, and the node location number is 0201, the actual location information may be jifang101 di2lie di3ge-0201. Of course, the actual location information may be represented in other formats, such as 0201jifang101 di2lie di3ge.

In step 206, current location information is acquired from a field “BMC FRU chassis extra” of the target node server.

In step 207, it is judged whether the current location information of the target node server is identical to the actual location information of the target node server. Step 208 is executed in a case where the current location information of the target node server is identical to the actual location information of the target node server. Otherwise, step 209 is executed.

It is determined whether the location information stored in the field “BMC FRU chassis extra” of the target node server is accurate with this step.

Judging whether the current location information is identical to the actual location information may be performed in the following two manners.

In a first manner, it is judged whether the character string of the current location information is identical to the character string of the actual location information. If the character string of the current location information is identical to the character string of the actual location information, it is determined that the current location information is identical to the actual location information. Otherwise, it is determined that the current location information is different from the actual location information. For example, the current location information is jifang101 di2lie di3ge-0201, and the actual location information is jifang101 di2lie di3ge-05. The current location information and the actual location information contain different characters, and are determined to be different from each other.

In a second manner, it is judged whether a location corresponding to the current location information is the same as a location corresponding to the actual location information. If the location corresponding to the current location information is the same as the location corresponding to the actual location information, it is determined that the current location information is identical to the actual location information. Otherwise, it is determined that the current location information is different from the actual location information. For example, the current location information is jifang101 di2lie di3ge-0301, which corresponds to the left-most location on the second layer of the third rack in the second column in the server room 101, and the actual location information is jifang101 di2lie di3ge-05, which corresponds to the left-most location on the second layer of the third rack in the second column in the server room 101. The current location information and the actual location information correspond to the same location, thus it is determined that the current location information is identical to the actual location information.

In step 208, the current process is ended.

In step 209, a BMC corresponding to the target node server is controlled to set content of the field “BMC FRU chassis extra” of the target node server to be the actual location information.

For example, the actual location information is jifang101 di2lie di3ge-0301, and the content of the field “BMC FRU chassis extra” of the target node server is set to jifang101 di2lie di3ge-0301.

In the embodiments of the present disclosure, the actual location information of the target node server is determined based on the first location of the target node mid-plane to which the target node server is connected in the rack and the second location of the target node server in the target node mid-plane. In a case of determining that the current location information of the target node server is different from the actual location information of the target node server, the location information of the target node server is automatically set to be the actual location information. In a case where location information of a large number of node servers is required to be set, with this method, a great deal of time can be saved, the error probability can be reduced, the setting efficiency can be significantly improved, and efficiency of maintaining the node servers can be enhanced.

In the embodiment of the present disclosure, the method may be performed by the RMC corresponding to the rack where the target node server is located, and the steps are automatically performed by the RMC.

The RMC automatically write the content of the field “BMC FRU chassis extra” of the target node server back to the actual location information based on the actual location information of the target node server in a format of, for example, “the content of the field “RMC FRU chassis extra”-the node location number”.

In a case where the location information of the RMC and the location information of the node server in a new rack are all default, the field “RMC FRU chassis extra” of the RMC may be set using a tool or a smashCLP command. Then, the RMC performs the method according to the embodiments of the present disclosure to set the location information of each node server in the rack.

It is to be noted that, in the embodiments of the present disclosure, the field “BMC FRU chassis extra” refers to the field “chassis extra” in FRU information of the BMC, and the field “RMC FRU chassis extra” refers to the field “chassis extra” in FRU information of the RMC.

For the node servers in a same rack, the rack location information in the content of the fields “BMC FRU chassis extra” of respective node servers are the same, and the rack location information is identical to the content of the field “RMC FRU chassis extra”, where the “identical” herein indicates that the character strings are identical or the corresponding locations are the same. One may refer to step 207 for detailed description.

Further, in order to guarantee the accuracy of the location information in the node server in the rack, the node servers in the rack may be polled periodically, and the currently polled node server may be regarded as the target node server. The polling process may be performed by the RMC.

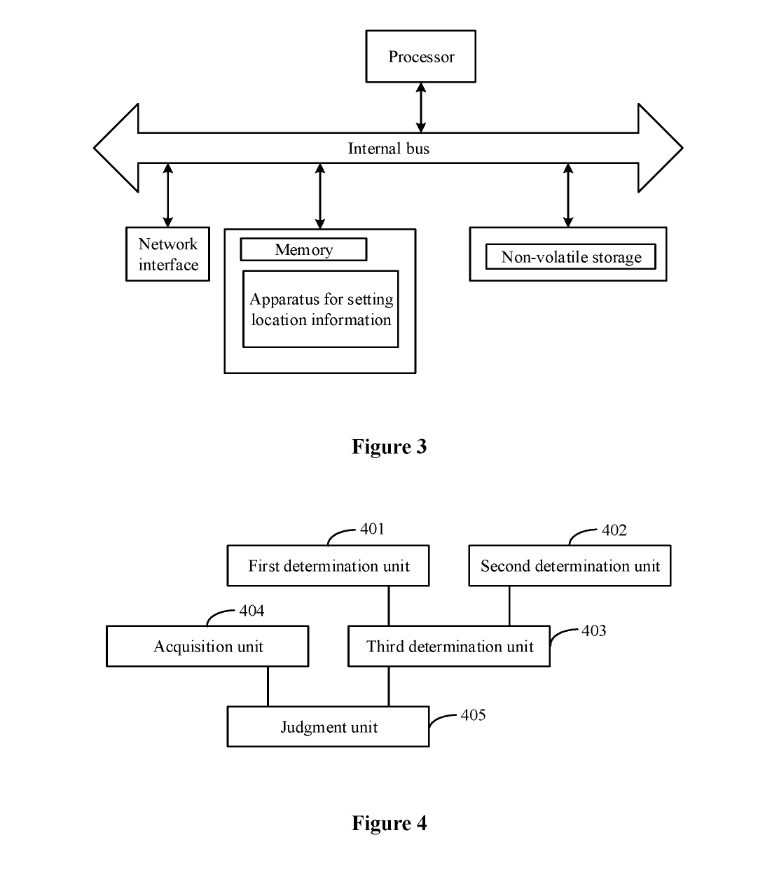

As shown in FIGS. 3 and 4, an apparatus for setting location information is provided according to the embodiments of the present disclosure. The apparatus embodiment may be implemented by software, hardware or the combination of software and hardware. From the aspect of hardware, reference is made to FIG. 3, which is a schematic structural diagram of hardware of a device where an apparatus for setting location information is located according to an embodiment of the disclosure. Besides the processor, the memory, the network interface and the non-volatile storage illustrated in FIG. 3, the device where the apparatus is located according to this embodiment may further include other hardware, such as a forwarding chip which is responsible for processing messages. Taking the software implementation as an example, as shown in FIG. 4, as a logical apparatus, the apparatus is formed by a CPU in the device where the apparatus is located reading corresponding computer program instructions in the non-volatile storage to the memory and running the computer program instructions. An apparatus for setting location information provided according to this embodiment includes a first determination unit 401, a second determination unit 402, a third determination unit 403, an acquisition unit 404, and a judgment unit 405.

The first determination unit 401 is configured to determine a first location of a target node mid-plane to which a target node server is connected in a rack.

The second determination unit 402 is configured to determine a second location of the target node server in the target node mid-plane.

The third determination unit 403 is configured to determine actual location information of the target node server based on the first location and the second location corresponding to the target node server.

The acquisition unit 404 is configured to acquire current location information of the target node server.

The judgment unit 405 is configured to judge whether the current location information of the target node server is identical to the actual location information of the target node server, and set location information of the target node server to be the actual location information in a case where the current location information of the target node server is not identical to the actual location information of the target node server.

In an embodiment of the present disclosure, the third determination unit is configured to determine a node location number of the target node server in the rack based on the first location and the second location; determine rack location information of the rack; and generate the actual location information based on the rack location information and the node location number.

In an embodiment of the present disclosure, the acquisition unit is configured to acquire the current location information from a field “BMC FRU chassis extra” of the target node server.

In an embodiment of the present disclosure, the judgment unit is configured to control a BMC corresponding to the target node server to set content of the field “BMC FRU chassis extra” of the target node server to be the actual location information when setting the location information of the target node server to be the actual location information.

In an embodiment of the present disclosure, the third determination unit is configured to use content of a field “RMC FRU chassis extra” of a RMC of the rack as the rack location information when determining the rack location information of the rack.

An apparatus for setting location information according to any of the embodiments of the present disclosure may be implemented by the RMC corresponding to the rack where the target node server is located.

Since the information interaction and the implementation processes between units in the apparatus are based on the same concept as the method embodiments of the present disclosure, one may referred to the description of the method embodiments of the present disclosure for the detailed description, which is not repeated here.

The embodiments of the present disclosure have at least the following beneficial effects.

1 [symbol] In the embodiments of the present disclosure, the actual location information of the target node server is determined based on the first location of the target node mid-plane to which the target node server is connected in the rack and the second location of the target node server in the target node mid-plane. The actual location of the target node server can be automatically determined with the method without manual searching. In a case of determining that the current location information of the target node server is different from the actual location information of the target node server, the location information of the target node server is automatically set to be the actual location information without manual setting, which improves the efficiency of setting the location information.

2 [symbol] In the embodiments of the present disclosure, the actual location information of the target node server is determined based on the first location of the target node mid-plane to which the target node server is connected in the rack and the second location of the target node server in the target node mid-plane. In a case of determining that the current location information of the target node server is different from the actual location information of the target node server, the location information of the target node server is automatically set to be the actual location information. In a case where location information of a large number of node servers is required to be set, with this method, a great deal of time can be saved, the error probability can be reduced, the setting efficiency can be significantly improved, and efficiency of maintaining the node servers can be enhanced.

It should be noted that the relationship terminologies such as “first”, “second” and the like are only used herein to distinguish one entity or operation from another, rather than to necessitate or imply that the actual relationship or order exists between the entities or operations. Furthermore, terms of “include”, “comprise” or any other variants are intended to be non-exclusive. Therefore, a process, method, article or device including a plurality of elements includes not only the elements but also other elements that are not enumerated, or also include the elements inherent for the process, method, article or device. Unless expressively limited otherwise, the statement “comprising (including) one . . . ” does not exclude the case that other similar elements may exist in the process, method, article or device.

It is to be understood by those skilled in the art that all of or some of steps of the above method embodiments may be performed by instructing corresponding hardware through a program. The proceeding program may be stored in a computer readable storage medium. When being executed, the program performs the steps of the above method embodiments. The proceeding storage medium includes various mediums capable of storing program codes, such as a ROM, an RAM, a magnetic disc or an optic disc.

Finally, it should be noted that the description above are only preferred embodiments of the present disclosure, which are merely provided for describing the technical solutions of the present application, but are not intended to limit the scope of present disclosure. Any modification, equivalent substitution, and improvement made without departing from the spirit and principle of the present disclosure are included in the scope of present disclosure.

1. A method for setting location information, comprising:
determining a first location of a target node mid-plane to which a target node server is connected in a rack;
determining a second location of the target node server in the target node mid-plane;
determining actual location information of the target node server based on the first location and the second location corresponding to the target node server;
acquiring current location information of the target node server; and
judging whether the current location information of the target node server is identical to the actual location information of the target node server, and setting location information of the target node server to be the actual location information in a case where the current location information of the target node server is not identical to the actual location information of the target node server.

2. The method according to claim 1, wherein the determining the actual location information of the target node server based on the first location and the second location corresponding to the target node server comprises:
determining a node location number of the target node server in the rack based on the first location and the second location;
determining rack location information of the rack; and
generating the actual location information based on the rack location information and the node location number.

3. The method according to claim 1, wherein the acquiring the current location information of the target node server comprises:
acquiring the current location information from a field “baseboard management controller (BMC) field replace unit (FRU) chassis extra” of the target node server.

4. The method according to claim 3, wherein the setting the location information of the target node server to be the actual location information comprises:
controlling a BMC corresponding to the target node server to set content of the field “BMC FRU chassis extra” of the target node server to be the actual location information.

5. The method according to claim 2, wherein the determining the rack location information of the rack comprises:
using content of a field “RMC FRU chassis extra” of a rack management controller (RMC) of the rack as the rack location information.

6. An apparatus for setting location information, comprising:
a first determination unit configured to determine a first location of a target node mid-plane to which a target node server is connected in a rack;
a second determination unit configured to determine a second location of the target node server in the target node mid-plane;
a third determination unit configured to determine actual location information of the target node server based on the first location and the second location corresponding to the target node server;
an acquisition unit configured to acquire current location information of the target node server; and
a judgment unit configured to judge whether the current location information of the target node server is identical to the actual location information of the target node server, and set location information of the target node server to be the actual location information in a case where the current location information of the target node server is not identical to the actual location information of the target node server.

7. The apparatus according to claim 6, wherein the third determination unit is configured to
determine a node location number of the target node server in the rack based on the first location and the second location;
determine rack location information of the rack; and
generate the actual location information based on the rack location information and the node location number.

8. The apparatus according to claim 6, wherein
the acquisition unit is configured to acquire the current location information from a field “baseboard management controller (BMC) field replace unit (FRU) chassis extra” of the target node server.

9. The apparatus according to claim 8, wherein
the judgment unit is configured to control a BMC corresponding to the target node server to set content of the field “BMC FRU chassis extra” of the target node server to be the actual location information when setting the location information of the target node server to be the actual location information.

10. The apparatus according to claim 7, wherein
the third determination unit is configured to use content of a field “RMC FRU chassis extra” of a rack management controller (RMC) of the rack as the rack location information when determining the rack location information of the rack.

11. The method according to claim 2, wherein the acquiring the current location information of the target node server comprises:
acquiring the current location information from a field “baseboard management controller (BMC) field replace unit (FRU) chassis extra” of the target node server.

12. The method according to claim 11, wherein the setting the location information of the target node server to be the actual location information comprises:
controlling a BMC corresponding to the target node server to set content of the field “BMC FRU chassis extra” of the target node server to be the actual location information.

13. The apparatus according to claim 7, wherein
the acquisition unit is configured to acquire the current location information from a field “baseboard management controller (BMC) field replace unit (FRU) chassis extra” of the target node server.

14. The apparatus according to claim 13, wherein
the judgment unit is configured to control a BMC corresponding to the target node server to set content of the field “BMC FRU chassis extra” of the target node server to be the actual location information when setting the location information of the target node server to be the actual location information.
